(19) United States
(12) Patent Application Publication
(10) Pub. No.: US 2026/0051673 A1
(43) Pub. Date: Feb. 19, 2026

(54) CONDUCTOR TERMINAL

(71) Applicant: WAGO Verwaltungsgesellschaft mbH, Minden (DE)

(72) Inventor: Henry STOLZE, Bad Frankenhausen (DE)

(73) Assignee: WAGO Verwaltungsgesellschaft mbH, Minden (DE)

(21) Appl. No.: 19/368,003

(22) Filed: Oct. 24, 2025

Related U.S. Application Data
(63) Continuation of application No. PCT/EP2024/061235, filed on Apr. 24, 2024.

(30) Foreign Application Priority Data
Apr. 26, 2023 (DE) 20 2023 102 238.3

(51) Int. Cl. H01R 4/48

(52) U.S. Cl. CPC H01R 4/4811; H01R 4/48185; H01R 4/484

(57) ABSTRACT

A conductor terminal having a housing, a first spring-loaded clamping connection connecting a first electrical conductor, and a second spring-loaded clamping connection connecting a second electrical conductor. The first spring-loaded clamping connection is electrically connected to the second spring-loaded clamping connection. The first spring-loaded clamping connection has a first clamping spring and a first counter bearing, between which a first clamping point is formed where the first electrical conductor can be clamped between the first clamping spring and the first counter bearing. The second spring-loaded clamping connection has a second clamping spring and a second counter bearing, between which a second clamping point is formed where the second electrical conductor can be clamped between the second clamping spring and the second counter bearing. The first clamping point and the second clamping point are arranged in the interior of the housing at a distance from outer walls of the housing.

This nonprovisional application is a continuation of International Application No. PCT/EP2024/061235, which was filed on Apr. 24, 2024, and which claims priority to German Patent Application No. 20 2023 102 238.3, which was filed in Germany on Apr. 26, 2023, and which are both herein incorporated by reference.

### BACKGROUND OF THE INVENTION

### Field of the Invention

The invention relates to a conductor terminal having at least the following features: a housing, a first spring-loaded clamping connection for connecting a first electrical conductor, a second spring-loaded clamping connection for connecting a second electrical conductor, wherein the first spring-loaded clamping connection is connected to the second spring-loaded clamping connection in an electrically conductive manner, wherein the first spring-loaded clamping connection has a first clamping spring and a first counter bearing, between which a first clamping point is formed where the first electrical conductor can be clamped between the first clamping spring and the first counter bearing, wherein the second spring-loaded clamping connection has a second clamping spring and a second counter bearing, between which a second clamping point is formed where the second electrical conductor can be clamped between the second clamping spring and the second counter bearing, and wherein the first clamping point and the second clamping point are arranged in the interior of the housing at a distance from the outer walls of the housing.

### Description of the Background Art

A conductor terminal is known from DE 1 917 503 A1, which is incorporated herein by reference.

### SUMMARY OF THE INVENTION

It is therefore an object of the present invention to provide a further improved conductor terminal, which can be easily miniaturized, in particular for the connection of small cross-section electrical conductors.

This object is achieved, in an example, with a conductor terminal in that a first counter bearing and/or a second counter bearing are formed from a insulating material, in particular from a material of the housing. Such a conductor terminal can be designed in particular without a separate busbar or even completely without a busbar. The current transmission between the first and second spring-loaded clamping connection then takes place via the first and second clamping spring and their electrical connection. In this way, the conductor terminal can be designed very simply and with few components; in particular it can be formed only or substantially only of the housing, the first and second clamping springs, and the electrical connection between the clamping springs.

Advantageously, the first counter bearing and/or the second counter bearing can be formed directly from the material of the housing, e.g., by an inner wall formed for this purpose in the interior of the housing. The housing can be formed of an insulating material. This enables a particularly cost-effective production of the conductor terminal and simplifies assembly even further.

The conductor terminal can be miniaturized particularly well due to its simple design and the merely few components.

The first and second clamping spring can be formed as a one-piece metal part. This makes the manufacture of the conductor terminal even more cost-effective and further simplifies assembly. The metal part having the first and second clamping spring can be mounted in the material of the housing, e.g., in the central area, in particular in an area between a first and second clamping leg, and can be fixed therein.

The metal part having the first and second clamping spring may be the only metal part of the conductor terminal. This makes the manufacture of the conductor terminal even more cost-effective and further simplifies assembly.

The metal part having the first and second clamping spring can be made of a copper alloy. The contact resistance for current transmission is minimized hereby and the current-carrying capacity of the metal part is increased. The first and second clamping springs can still have sufficient spring properties, even if they are not made of a conventional spring steel as is otherwise used for clamping springs.

The first clamping spring can have a first contact leg for fixing the first clamping spring in the housing, a first clamping leg for clamping the first electrical conductor at the first clamping point, and a first spring bow arranged between the first clamping leg and the first contact leg and/or the second clamping spring has a second contact leg for fixing the second clamping spring in the housing, a second clamping leg for clamping the second electrical conductor at the second clamping point, and a second spring bow arranged between the second clamping leg and the second contact leg. A particularly good spring effect can be achieved hereby with a compact first and/or second clamping spring. The contact legs allow the first and/or second clamping spring to be securely fixed in the housing, e.g., by corresponding housing walls between which the first contact leg and/or the second contact leg are guided.

The conductor terminal according to the invention is particularly suitable for applications with relatively small conductors, e.g., with conductor cross sections of 0.03 mm² to 0.2 mm², and/or for low currents, e.g., up to a maximum of 2 A. The conductor terminal is suitable, e.g., for model making applications, in toys, in telecommunications equipment, and computer network connections.

The first clamping leg can hold the first clamping spring with a slight pretension in relation to the first counter bearing, even when the electrical conductor is not inserted. The same applies to the second clamping leg.

The first clamping leg can have a window-like first through-opening, which is designed to pass through the first electrical conductor and/or the second clamping leg has a window-like second through-opening, which is designed to pass through the second electrical conductor. In this way, the respective electrical conductor can be clamped particularly effectively at the clamping point. The first and/or second clamping leg can have a clamping edge for clamping the electrical conductor. The window-like first and/or second through-opening can be round, oval, or polygonal, e.g., quadrangular, in particular rectangular. The window-like first and/or second through-opening can be surrounded on three or four sides by the material of the first clamping leg.

A first clamping tab can extend out on the first clamping leg, for example, on the inner circumference of the first through-opening, which tab is designed for clamping the first electrical conductor to the first counter bearing, and/or a second clamping tab extends out on the second clamping leg, in particular on the inner circumference of the second through-opening, which tab is designed for clamping the second electrical conductor to the second counter bearing. As a result, the electrical conductor can be fixed particularly securely by clamping using the clamping spring. For example, the aforementioned clamping edge can be arranged on the first clamping tab or on the second clamping tab. In an example, the first clamping tab can be bent away from the first clamping leg in the conductor insertion direction of the first electrical conductor and/or in the direction of the first contact leg. It is also possible for the first clamping tab to be bent opposite to the conductor insertion direction of the first electrical conductor and/or away from the first contact leg. In this case, it can be advantageous if there is a clearance and a counter bearing in the area of the first conductor insertion opening or the first conductor insertion channel. In an example, the second clamping tab can be bent away from the second clamping leg in the conductor insertion direction of the second electrical conductor and/or in the direction of the second contact leg. It is also possible for the second clamping tab to be bent opposite to the conductor insertion direction of the second electrical conductor and/or away from the second contact leg. In this case, it can be advantageous if there is a clearance and a counter bearing in the area of the second conductor insertion opening or the second conductor insertion channel.

The clamping tab can be bent away from the clamping leg, e.g., at a relatively small angle, e.g., in the range from 5 degrees to 45 degrees. The clamping tab can also be bent away at a larger angle, e.g., up to 60 degrees or up to 90 degrees or more. In particular, a flat pitch angle, which is adapted to relatively thin electrical conductors, can be achieved during clamping with this geometry of the clamping tab, as well as the holding of the clamping spring at a defined pretension. In particular, this prevents such a conductor from being unintentionally cut by the clamping leg. Particularly with larger bending angles, e.g., greater than 80 degrees or greater than 90 degrees, the clamping tab can form a pressure surface for pressing the electrical conductor against the respective counter bearing; i.e., in this case the electrical conductor is not clamped by a clamping edge but by the pressure surface of the clamping tab. The design with such a pressure surface has the advantage that the risk of cutting the clamped electrical conductor is minimized by the pressure, especially with relatively thin conductors.

The first contact leg can be connected to the first spring bow via a first connecting section, wherein the first connecting section is arranged at an angle between 10 degrees and 80 degrees obliquely to the first contact leg and/or the second contact leg is connected to the second spring bow via a second connecting section, wherein the second connecting section is arranged at an angle between 10 degrees and 80 degrees obliquely to the second contact leg. This enables the first and/or second clamping spring to be securely fixed in the housing in the conductor insertion direction of the respective electrical conductor, e.g., by corresponding housing walls, between which the first contact leg and/or the second contact leg are guided. The metal part having the first and second clamping springs can then be formed w-shaped, for example.

The first spring bow can have a bending direction opposite to a bend between the first contact leg and the first connecting section and/or the second spring bow has a bending direction opposite to a bend between the second contact leg and the second connecting section. In this way, the first and second clamping springs can be integrated particularly well and in a space-saving manner into a compact housing. In addition, a simple and efficient manual actuation of the first and/or second clamping spring is possible, as explained below.

Manual actuation of the first spring-loaded clamping connection and/or the second spring-loaded clamping connection to open the respective clamping point by manual actuation can be carried out, e.g., using a separate actuation tool, e.g., by pressing on the respective clamping spring with a screwdriver.

The conductor terminal can have a first actuation element for manually actuating the first spring-loaded clamping connection and/or a second actuation element for manually actuating the second spring-loaded clamping connection. Because the conductor terminal has its own actuation elements for the manual actuation, an easy actuation by the user is possible at any time, particularly without additional tools.

The first actuation element can be designed as an actuating pusher or actuating lever, in particular as an actuating pusher or actuating lever integrally molded with the material of the housing, and/or the second actuation element is designed as an actuating pusher or actuating lever, in particular as an actuating pusher or actuating lever integrally molded with the material of the housing. Such an actuation element allows ergonomic and intuitive operation of the conductor terminal. In addition, such actuation elements can be integrated into a miniaturized housing particularly inexpensively, especially if the design is integrally formed with the housing material.

The first actuation element can be designed for transmitting a manual actuating force to the first spring bow and/or the second actuation element is designed for transmitting a manual actuating force to the second spring bow. This is also beneficial for the design of the conductor terminal in a miniaturized form. In particular, no additional elements are required on the first and/or second clamping spring, such as, e.g., a separate actuating tab.

The conductor terminal can be designed as a feed-through terminal, wherein the housing has a first conductor insertion opening associated with the first spring-loaded clamping connection and a second conductor insertion opening associated with the second spring-loaded clamping connection, wherein the first and second conductor insertion openings are arranged on diametrically mutually opposite sides of the housing. This type of feed-through terminal is suitable for a wide range of electrical wiring tasks, particularly for use in installation boxes. The conductor terminal can be formed in particular as a socket terminal.

The first spring-loaded clamping connection can be designed as a push-in connection and/or the second spring-loaded clamping connection is designed as a push-in connection. If the first and/or second clamping spring have a compact design, this allows a high clamping force and accordingly secure clamping of the respective electrical conductor. The push-in connection can be designed, e.g., similar to a cage tension spring.

The first spring-loaded clamping connection can be designed to pull the first electrical conductor in a direction towards the first counter bearing by means of the first clamping spring, which direction faces away from the outer wall of the housing closest to the first clamping point, and/or the second spring-loaded clamping connection is designed to pull the second electrical conductor in a direction towards the second counter bearing by means of the second clamping spring, which direction faces away from the outer wall of the housing closest to the second clamping point. The connected conductor is thus centered in the housing by the first and/or second spring-loaded clamping connection, e.g., arranged approximately centrally in the housing when it is clamped, e.g., centrally in the conductor insertion direction and/or transverse to the conductor insertion direction. This enables good insulation reliability even with miniaturized conductor terminals.

The first clamping spring can be designed as a tension spring with a first contact leg facing away from the first through-opening and/or the second clamping spring is designed as a tension spring with a second contact leg facing away from the second through-opening.

A first conductor receiving space for receiving the first electrical conductor and a second conductor receiving space for receiving the second electrical conductor can be formed in the housing, wherein the housing has at least one partition wall by which the first conductor receiving space is separated from the second conductor receiving space. The partition wall can therefore be made from the material of the housing.

The first and/or second conductor receiving space can have a stop to limit the insertion depth of the electrical conductor. Advantageously, the stop can be formed by the partition wall.

The conductor terminal can have a plurality of first spring-loaded terminal connections arranged in the housing next to one another in a series mounting direction, into each of which a first electrical conductor can be inserted via a first conductor insertion opening assigned to the respective first spring-loaded terminal connection, wherein the first conductor insertion openings are arranged on the same first conductor insertion side of the housing. In addition, the conductor terminal can have a second spring-loaded terminal connection assigned to each first spring-loaded terminal connection. As a result, the conductor terminal is suitable for connecting a large number of electrical conductors. The first spring-loaded terminal connections can be electrically isolated from each other or partially or fully electrically connected to each other.

In this case, the housing of the conductor terminal can be a continuous housing in the series mounting direction, which accommodates multiple or all first and second spring-loaded terminal connections. The conductor terminal can also be designed as a modular terminal block, in which a plurality of disk-shaped housing modules are arranged next to each other in the series mounting direction and connected to each other. Such a housing module can then accommodate, e.g., a first and second spring-loaded terminal connection. For example, the housing modules can be latched together, e.g., via latching pins and latching recesses, wherein an end plate (cover) can be latched onto the end of such a terminal block.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor terminal in the open state;

FIG. 2 shows the clamping spring of the conductor terminal according to FIG. 1;

FIG. 3 shows the conductor terminal according to FIG. 1 with connected electrical conductors; and

FIG. 4 shows a multi-pole terminal block assembled from multiple conductor terminals.

### DETAILED DESCRIPTION

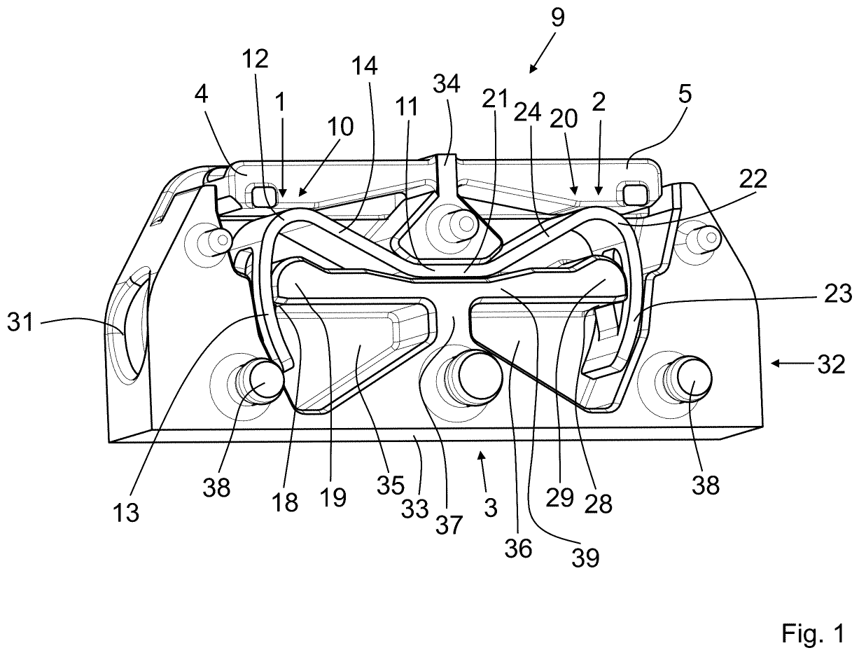

FIG. 1 shows a conductor terminal 9 with a housing 3 and a first spring-loaded clamping connection 1 for connecting a first electrical conductor and a second spring-loaded clamping connection 2 for connecting a second electrical conductor. First spring-loaded clamping connection 1 and second spring-loaded clamping connection 2 are arranged in housing 3.

First spring-loaded clamping connection 1 has a first clamping spring 10 and a first counter bearing 19, between which a first clamping point 18 is formed where the first electrical conductor can be clamped between first clamping spring 10 and first counter bearing 19. First clamping spring 10 has a first clamping leg 13 for clamping the first electrical conductor. A first spring bow 12 is connected to first clamping leg 13. To fix first clamping spring 10 in housing 3, first clamping spring 10 has a first contact leg 11. First contact leg 11 is connected to first spring bow 12 via a first connecting section 14.

Second spring-loaded clamping connection 2 has a second clamping spring 20 and a second counter bearing 29, between which a second clamping point 28 is formed where the second electrical conductor can be clamped between second clamping spring 20 and second counter bearing 29. Second clamping spring 20 has a second clamping leg 23 for clamping the second electrical conductor. A second spring bow 22 is connected to second clamping leg 23. To fix second clamping spring 20 in housing 3, second clamping spring 20 has a second contact leg 21. Second contact leg 21 is connected to second spring bow 22 via a second connecting section 24.

First contact leg 11 is connected to second contact leg 21, e.g., in that the first and second clamping springs 10, 20 are formed as a one-piece metal part.

First clamping point 18 and second clamping point 28 are arranged inside housing 3, in particular at a distinct distance from outer walls 33, 34 of housing 3. An inner wall 39 made of the housing material and extending in the longitudinal direction is arranged inside housing 3, which wall forms first counter-bearing 19 at one end and second counter-bearing 29 at the other end.

Housing 3 has a first conductor insertion opening 31, through which the first electrical conductor can be inserted into housing 3 and guided to first clamping point 18. The stripped part, inserted there, of the first electrical conductor is then arranged in a first conductor receiving space 35. Housing 3 has a second conductor insertion opening 32, through which the second electrical conductor can be inserted into housing 3 and guided to second clamping point 28. The second electrical conductor is then arranged in a second conductor receiving space 36.

To actuate first spring-loaded clamping connection 1, conductor terminal 9 has a first actuation element 4, which is designed, e.g., as a actuating pusher. To actuate second spring-loaded clamping connection 2, conductor terminal 9 has a second actuation element 5, which is designed as an actuating pusher, for example. First actuation element 4 and/or second actuation element 5 can be formed integrally with the material of housing 3, e.g., integrally with outer housing wall 34. First actuation element 4 is used to transmit a manually applied actuating force to first spring bow 12, whereby first spring bow 12 can be deflected downwards together with first clamping leg 13, and first clamping point 18 is opened thereby. Second actuation element 5 is used to transmit a manually applied actuating force to second spring bow 22, whereby second spring bow 22 can be deflected downwards together with second clamping leg 23 and second clamping point 28 is opened thereby. When the respective actuation element 4, 5 is actuated, it then performs a slight pivoting movement.

Conductor terminal 9 can be designed to be series mounted and assembled with other conductor terminals in a series mounting direction to form a multi-pole terminal block. For this purpose, first latching elements 38 can be formed on one side on housing 3, and second latching elements, which are not visible in FIG. 1, can be present on the opposite side of the housing. For example, first latching elements 38 can be designed as pins projecting from housing 3, and the second latching elements as counterparts to the pins, i.e., in the form of recesses in housing 3. In this way, a plurality of conductor terminals 9 with their housings 3 can be assembled to form a terminal block according to the Lego principle.

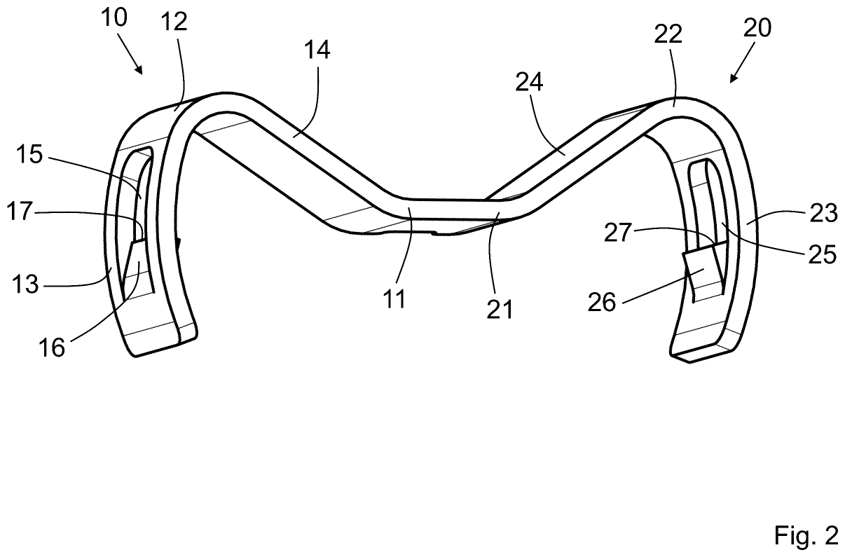

FIG. 2 shows the metal part that has first clamping spring 10 and second clamping spring 20. It can be seen that first clamping leg 13 has a first window-like through-opening 15 through which the first electrical conductor is to be passed. On first clamping leg 13, a first clamping tab 16 extends out on the inner circumference of first through-opening 15 and is bent slightly in the direction of first contact leg 11 relative to first clamping leg 13. A clamping edge 17 for clamping the electrical conductor can be formed at the free end of first clamping tab 16, whereby the pitch angle of the free end of first clamping tab 16 towards first clamping edge 17 can be relatively small in order to avoid damage to the first electrical conductor. In addition, second clamping leg 23 has a second window-like through-opening 25 through which the second electrical conductor is to be passed. On second clamping leg 23, a second clamping tab 26 extends out on the inner circumference of second through-opening 25 and is bent slightly in the direction of second contact leg 21 relative to second clamping leg 23. A clamping edge 27 for clamping the second electrical conductor can be formed at the free end of second clamping tab 26, whereby the pitch angle of the free end of second clamping tab 26 towards second clamping edge 27 can be relatively small in order to avoid damage to the second electrical conductor.

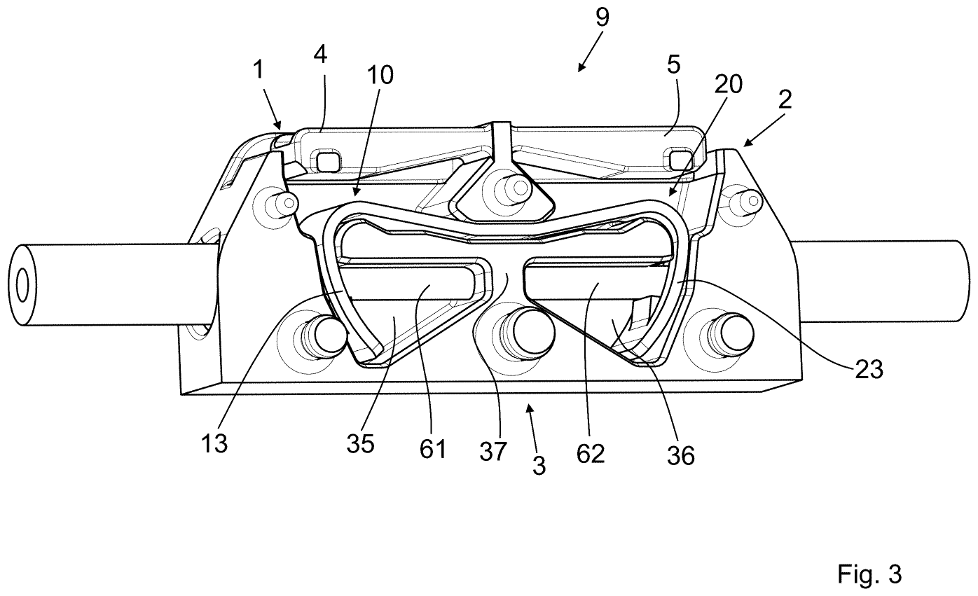

FIG. 3 shows conductor terminal 9 with a first electrical conductor 61 clamped to first spring-loaded clamping connection 1 and a second electrical conductor 62 clamped to second spring-loaded clamping connection 2.

First conductor receiving space 35 is separated from second conductor receiving space 36 by a partition wall 37 formed by housing 3. Partition wall 37 at the same time forms a stop for limiting the insertion depth for both first electrical conductor 61 and second electrical conductor 62.

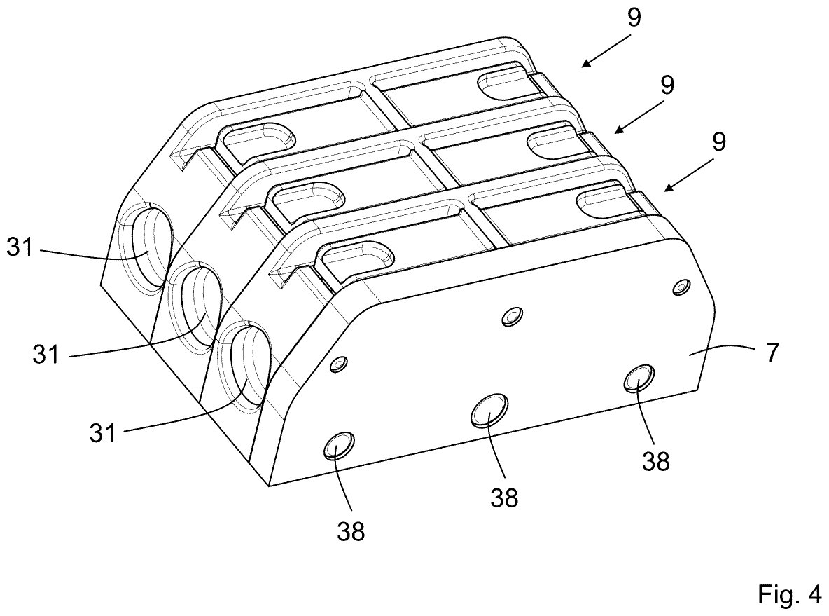

FIG. 4 shows a terminal block assembled from a plurality of conductor terminals 9. The remaining open side of the last conductor terminal 9 of the series arrangement is covered by an end plate 7, which can be latched onto housing 3 of the last conductor terminal 9 in the same way as individual housings 3 are latched together, i.e., using first latching elements 38.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
a housing;
a first spring-loaded clamping connection connecting a first electrical conductor; and
a second spring-loaded clamping connection connecting a second electrical conductor,
wherein the first spring-loaded clamping connection is connected to the second spring-loaded clamping connection in an electrically conductive manner,
wherein the first spring-loaded clamping connection has a first clamping spring and a first counter bearing, between which a first clamping point is formed where the first electrical conductor is adapted to be clamped between the first clamping spring and the first counter bearing,
wherein the second spring-loaded clamping connection has a second clamping spring and a second counter bearing, between which a second clamping point is formed where the second electrical conductor is adapted to be clamped between the second clamping spring and the second counter bearing,
wherein the first clamping point and the second clamping point are arranged in an interior of the housing at a distance from outer walls of the housing, and
wherein the first counter bearing and/or the second counter bearing are formed from an insulating material.

2. The conductor terminal according to claim 1, wherein the first and second clamping springs are formed as a one-piece metal part.

3. The conductor terminal according to claim 2, wherein the metal part having the first and second clamping spring is the only metal part of the conductor terminal.

4. The conductor terminal according to claim 2, wherein the metal part having the first and second clamping spring is made of a copper alloy.

5. The conductor terminal according to claim 1, wherein the first clamping spring comprises:
a first contact leg to fix the first clamping spring in the housing;
a first clamping leg to clamp the first electrical conductor at the first clamping point; and
a first spring bow arranged between the first clamping leg and the first contact leg, and/or
wherein the second clamping spring comprises:
a second contact leg to fix the second clamping spring in the housing;
a second clamping leg to clamp the second electrical conductor at the second clamping point; and
a second spring bow arranged between the second clamping leg and the second contact leg.

6. The conductor terminal according to claim 1, wherein the first clamping leg comprises a window-like first through-opening, which is designed to pass through the first electrical conductor and/or wherein the second clamping leg comprises a window-like second through-opening, which is designed to pass through the second electrical conductor.

7. The conductor terminal according to claim 1, wherein a first clamping tab extends out on the first clamping leg or on an inner circumference of the first through-opening, the first clamping tab being designed to clamp the first electrical conductor to the first counter bearing, and/or wherein a second clamping tab extends out on the second clamping leg or on the inner circumference of the second through-opening, the second clamping tab being designed to clamp the second electrical conductor to the second counter bearing.

8. The conductor terminal according to claim 1, wherein the first contact leg is connected to the first spring bow via a first connecting section, wherein the first connecting section is arranged at an angle between 10 degrees and 80 degrees obliquely to the first contact leg and/or the second contact leg is connected to the second spring bow via a second connecting section, and wherein the second connecting section is arranged at an angle between 10 degrees and 80 degrees obliquely to the second contact leg.

9. The conductor terminal according to claim 8, wherein the first spring bow has a bending direction opposite to a bend between the first contact leg and the first connecting section and/or wherein the second spring bow has a bending direction opposite to a bend between the second contact leg and the second connecting section.

10. The conductor terminal according to claim 1, wherein the conductor terminal has a first actuation element to manually actuate the first spring-loaded clamping connection and/or a second actuation element to manually actuate the second spring-loaded clamping connection.

11. The conductor terminal according to claim 10, wherein the first actuation element is designed as an actuating pusher or actuating lever or as an actuating pusher or actuating lever integrally molded with the material of the housing, and/or wherein the second actuation element is designed as an actuating pusher or actuating lever or as an actuating pusher or actuating lever integrally molded with the material of the housing.

12. The conductor terminal according to claim 10, wherein the first actuation element transmits a manual actuating force to the first spring bow, and/or wherein the second actuation element transmits a manual actuating force to the second spring bow.

13. The conductor terminal according to claim 1, wherein the conductor terminal is a feed-through terminal, wherein the housing has a first conductor insertion opening associated with the first spring-loaded clamping connection and a second conductor insertion opening associated with the second spring-loaded clamping connection, and wherein the first and second conductor insertion openings are arranged on diametrically mutually opposite sides of the housing.

14. The conductor terminal according to claim 1, wherein the first spring-loaded clamping connection a push-in connection and/or the second spring-loaded clamping connection is a push-in connection.

15. The conductor terminal according to claim 1, wherein the first spring-loaded clamping connection is designed to pull the first electrical conductor in a direction towards the first counter bearing via the first clamping spring, which direction faces away from the outer wall of the housing closest to the first clamping point, and/or wherein the second spring-loaded clamping connection is designed to pull the second electrical conductor in a direction towards the second counter bearing via the second clamping spring, which direction faces away from the outer wall of the housing closest to the second clamping point.

16. The conductor terminal according to claim 1, wherein the first clamping spring is a tension spring with a first contact leg facing away from the first through-opening, and/or wherein the second clamping spring is a tension spring with a second contact leg facing away from the second through-opening.

17. The conductor terminal according to claim 1, wherein a first conductor receiving space to receive the first electrical conductor and a second conductor receiving space to receive the second electrical conductor are formed in the housing, wherein the housing has at least one partition via which the first conductor receiving space is separated from the second conductor receiving space.

18. The conductor terminal according to claim 1, wherein the insulating material is substantially the same material that the housing is formed of.
